(19) United States
(12) Patent Application Publication
(10) Pub. No.: US 2024/0145805 A1
(43) Pub. Date: May 2, 2024

(54) A METHOD FOR TARGET METAL REMOVAL VIA SULPHIDE PRECIPITATION

(71) Applicant: LI-CYCLE CORP., Toronto (CA)

(72) Inventors: Christopher James Biederman, Hannon (CA); Darcy Lionel Tait, Uxbridge (CA); Timothy George Johnston, Toronto (CA); Sean Patrick Grixti, Toronto (CA); Olga Misic, Etobicoke (CA)

(73) Assignee: LI-CYCLE CORP., Toronto, ON (CA)

(21) Appl. No.: 18/548,781

(22) PCT Filed: Mar. 1, 2022
(86) PCT No.: PCT/CA2022/050290

§ 371 Date: Sep. 1, 2023

Related U.S. Application Data
(63) Continuation of application No. PCT/CA21/50266, filed on Mar. 2, 2021.
(60) Provisional application No. 63/230,895, filed on Aug. 9, 2021.

(51) Int. Cl. H01M 10/54; C22B 3/00; C22B 3/06; C22B 3/44; C22B 15/00

(52) U.S. Cl. CPC H01M 10/54; C22B 3/06; C22B 3/44; C22B 15/0071; C22B 17/04; C22B 23/043

(57) ABSTRACT

A method of precipitating copper sulphide from an incoming feed stream comprising copper liberated from within battery materials can includes the steps of: a) receiving an incoming feed stream comprising copper entrained in a carrier liquid in a precipitation apparatus; b) introducing a sulphide reductant to the feed stream to precipitate copper sulphide solids out of the feed stream during a precipitation residence time that is less than 24 hours to produce a copper sulphide slurry; and processing the copper sulphide slurry to separate the precipitated copper sulphide solids and provide a copper-depleted stream.

### CROSS-REFERENCE TO RELATED APPLICATIONS

This application claims the benefit of, and priority to U.S. provisional patent application No. 63/230,895, filed Aug. 9, 2021 and entitled A Method for Target Metal Removal via Sulphide Precipitation, and international patent application No. PCT/CA2021/050266 filed Mar. 2, 2021 and entitled A Method for Processing Lithium Iron Phosphate Batteries, both of these applications being incorporated herein in their entirety by reference.

### FIELD OF THE INVENTION

In one of its aspects, the present disclosure relates generally to a method for removing one or more target metals, such as copper, lithium, cadmium, cobalt, iron and/or nickel and others, from an incoming feed stream/solution that includes one or more of the target metals via sulphide precipitation, and in one embodiment to a method for removing/recovering copper from a slurry that contains black mass material and other materials that have been liberated from batteries, including lithium-ion batteries, such as via a mechanical disassembly or shredding process.

### INTRODUCTION

PCT publication no. WO1996/025361 discloses a method for separating copper and other metals in solution comprising the steps of precipitating the copper in a reactor at a free acid range of about 0.05 to 180 grams per liter, at a temperature from about 25° C. to about 90° C. in an aqueous solution with elemental sulfur, or chalcopyrite, and material selected from the group consisting of soluble sulfites and soluble bisulfites, and separating the precipitated copper, in the form of copper sulphides, by thickening the solution, recycling part to the precipitation step, and filtering copper sulphides from the other part.

U.S. Pat. No. 3,740,331 discloses how heavy metal pollutant ions can be removed from an aqueous solution in a sulfide precipitation process that avoids generation of noxious amounts of hydrogen sulfide and the formation of soluble complexes of sulfide ions. Sulfide ion and a heavy metal ion that forms a sulfide having a higher equilibrium sulfide ion concentration than the sulfide of the heavy metal pollutant are added to the solution. The added heavy metal acts as a scavenger for excess sulfide. In some cases the added heavy metal and the heavy metal pollutant form co-precipitates which result in more complete removal of the pollutant ion than could be achieved by sulfide precipitation of the pollutant alone.

U.S. Pat. No. 9,312,581 relates to a method for recycling lithium batteries and more particularly batteries of the Li-ion type and the electrodes of such batteries. This method for recycling lithium battery electrodes and/or lithium batteries comprises the following steps: a) grinding of said electrodes and/or of said batteries, b) dissolving the organic and/or polymeric components of said electrodes and/or of said batteries in an organic solvent, c) separating the undissolved metals present in the suspension obtained in step b), d) filtering the suspension obtained in step c) through a filter press, e) recovering the solid mass retained on the filter press in step d), and suspending this solid mass in water, f) recovering the material that sedimented or coagulated in step e), resuspending this sedimented material in water and adjusting the pH of the suspension obtained to a pH below 5, preferably below 4, g) filtering the suspension obtained in step f) on a filter press, and h) separating, on the one hand, the iron by precipitation of iron phosphates, and on the other hand the lithium by precipitation of a lithium salt. The method of the invention finds application in the field of recycling of used batteries, in particular.

International Patent Application No. WO2005/101564 a method for treating all types of lithium anode batteries and cells via a hydrometallurgical process at room temperature. Said method is used to treat, under safe conditions, cells and batteries including a metallic lithium anode or an anode containing lithium incorporated in an anode inclusion compound, whereby the metallic casings, the electrode contacts, the cathode metal oxides and the lithium salts can be separated and recovered.

US Patent Publication No. 2010/0230518 discloses a method of recycling sealed batteries, the batteries are shredded to form a shredded feedstock. The shredded feedstock is heated above ambient temperature and rolled to form a dried material. The dried material is screen separating into a coarse fraction and a powder fraction and the powder fraction is output. A system for recycling sealed cell batteries comprises an oven with a first conveyor extending into the oven. A rotatable tunnel extends within the oven from an output of the first conveyor. The tunnel has a spiral vane depending from its inner surface which extends along a length of the tunnel. A second conveyor is positioned below an output of the rotatable tunnel.

U.S. Pat. No. 8,858,677 discloses a valuable-substance recovery method according to the present invention includes: a solvent peeling step (S3) of dissolving a resin binder included in an electrode material by immersing crushed pieces of a lithium secondary battery into a solvent, so as to peel off the electrode material containing valuable substances from a metal foil constituting the electrode; a filtering step (S4) of filtering a suspension of the solvent, so as to separate and recover the electrode material containing the valuable substances and a carbon material; a heat treatment step (S5) of heating the recovered electrode material containing the valuable substances and the carbon material, under an oxidative atmosphere, so as to burn and remove the carbon material; and a reducing reaction step (S6) of immersing the resultant electrode material containing the valuable substances into a molten salt of lithium chloride containing metal lithium, so as to perform a reducing reaction.

### SUMMARY

Lithium-ion rechargeable batteries are increasingly powering automotive, consumer electronic, and industrial energy storage applications. An estimated 11+ million tonnes of spent lithium-ion battery packs are expected to be discarded between 2017 and 2030, driven by application of lithium-ion batteries in electro-mobility applications such as electric vehicles. Rechargeable lithium-ion batteries, including ternary, LFP, SSBs, and other types of batteries that may be processed using the teachings here, comprise a number of different materials within their battery cells.

A portion of the lithium-ion batteries can be described as ternary batteries, which can include lithium batteries that use lithium-nickel-manganese-cobalt-oxide (NMC) as the cathode and graphite as the anode. Other portions of the lithium-ion batteries can include lithium iron phosphate (LFP, or sometimes as a lithium ferrophosphate battery) batteries and these batteries may have a different composition than other types of lithium-ion batteries. For example, LFP batteries utilize LiFePO₄ as a cathode material, usually in combination with a graphitic carbon-based anode. LFP batteries typically include relatively lower amounts of metals, such as nickel and cobalt, than other types of lithium-ion batteries. As nickel and cobalt can be relatively valuable, the relatively low amounts of these metals in LFP batteries may make LFP batteries less desirable to recycle than other forms of batteries that would yield relatively larger amounts of these valuable metals.

Lithium-ion batteries are a type of rechargeable battery in which lithium ions drive an electrochemical reaction. Lithium has a high electrochemical potential and a high energy density. Lithium-ion battery cells have four key components: a. Positive electrode/cathode: including differing formulations of metal oxides or metal phosphate depending on battery application and manufacturer, intercalated on a cathode backing foil/current collector (e.g. aluminum)—for example: LiNixMnyCOzO2 (NMC); LiCoO2(LCO); LiFePO4 (LFP); LiMn2O4 (LMO); LiNiCoAlO2 (NCA); b. Negative electrode/anode: generally, comprises graphite intercalated on an anode backing foil/current collector (e.g. copper); c. Electrolyte: for example, lithium hexafluorophosphate (LiPF6), lithium tetrafluoroborate (LiBF4), lithium perchlorate (LiClO4), lithium hexafluoroarsenate monohydrate (LiAsF6·H₂O), lithium trifluoromethanesulfonate (LiCF3SO3), lithium bis(bistrifluoromethanesulphonyl) (LiC₂F₆NO₄S₂), lithium organoborates, or lithium fluoroalkylphosphates dissolved in an organic solvent (e.g., mixtures of alkyl carbonates, e.g. C1-C6 alkyl carbonates such as ethylene carbonate (EC, generally required as part of the mixture for sufficient negative electrode/anode passivation), ethyl methyl carbonate (EMC), dimethyl carbonate (DMC), diethyl carbonate (DEC), propylene carbonate (PC)); and d. Separator between the cathode and anode: for example, polymer or ceramic based.

“Black mass” as used herein refers to a combination of some of the components of rechargeable lithium-ion batteries or other types of batteries that can be liberated from within the cell during a processing step (such as a mechanical processing, disassembly and/or comminuting step) and includes at least a combination of cathode and/or anode electrode powders that may include lithium, nickel, cobalt, cadmium, iron, phosphorous, and manganese. Materials present in rechargeable lithium-ion batteries include the anode and cathode materials, as well as a suitable electrolyte (residual organic electrolyte such as C1-C6 alkyl carbonates, such as ethylene carbonate (EC), ethyl methyl carbonate (EMC), dimethyl carbonate (DMC), diethyl carbonate (DEC), propylene carbonate (PC), and mixtures thereof) and possibly a solid separator which may be sulphide, oxide, ceramic or glass for SSBs. Depending on the type of batteries, or mixture of types of batteries that are being processed then the metals included in the black mass may be expected to include lithium, nickel, cadmium, cobalt, iron, phosphorous, manganese and other such materials.

Large format lithium-ion battery packs (e.g. in automotive and stationary energy storage system applications) are generally structured as follows: a. Cells: cells contain the cathode, anode, electrolyte, separator, housed in steel, aluminum, and/or plastic; b. Modules: multiple cells make up a module, typically housed in steel, aluminum, and/or plastic; and c. Battery pack: multiple modules make up a battery pack, typically housed in steel, aluminum, and/or plastic.

Several of the materials in a lithium-ion battery or battery pack can be recycled and may form separate outputs from an overall battery recycling process. For example, as noted above, PCT patent publication no. WO2018/218358 discloses a process to recover materials from rechargeable lithium-ion batteries, thus recycling them. The process involves processing the batteries into a size-reduced feed stream; and then, via a series of separation, isolation, and/or leaching steps, allows for recovery of a copper product, cobalt, nickel, and/or manganese product, and a lithium product; and, optional recovery of a ferrous product, aluminum product, graphite product, etc. An apparatus and system for carrying out size reduction of batteries under immersion conditions is also provided. However, while shredding the incoming battery materials under immersion conditions, such as described in PCT patent publication no. WO2018/218358, can have some benefits there can also be some challenges in processing the battery materials using this method.

In accordance with one broad aspect of the teachings described herein a method of precipitating copper sulphide from an incoming feed stream comprising copper liberated from within battery materials can include the steps of: a) receiving an incoming feed stream comprising copper entrained in a carrier liquid in a precipitation apparatus; b) introducing a sulphide reductant to the feed stream to precipitate copper sulphide solids out of the feed stream during a precipitation residence time that is less than 24 hours to produce a copper sulphide slurry; and c) processing the copper sulphide slurry to separate the precipitated copper sulphide solids and provide a copper-depleted stream.

The reductant may be added to the incoming feed stream in step b) to reduce the oxidation reduction potential (ORP) of the copper sulphide slurry to between 0 mV and −200 mV.

The method may include after step c) the step of oxidizing the copper-depleted stream downstream from the precipitation apparatus to increase the ORP of the copper-depleted stream.

The method may include adjusting the ORP of the copper-depleted stream to be equal to or above 400 mV by introducing an oxidant into the copper-depleted stream.

The ORP may be about 500 mV.

Adjusting the ORP of the copper-depleted stream may include introducing at least one of oxygen gas, hydrogen peroxide, and perchloric acid.

The sulphide reductant may include at least one of sodium sulphide, sodium hydrosulphide, and hydrogen sulphide.

The sulphide reductant may include sodium hydrosulphide.

The sulphide reductant may be provided as a reductant solution that has a concentration of between about 5-20% wt sulphide reductant in solution.

The sulphide reductant may be introduced so that it has a molar concentration within the feed stream of between 1.2 and 1.6 times the molar concentration of copper in the incoming feed stream.

The sulphide reductant may be introduced so that it has a molar concentration within the feed stream of between 1.4 and 1.5 times the molar concentration of copper in the incoming feed stream, and preferably so that it has a molar concentration within the feed stream of between 1.4 and 1.45 times the molar concentration of copper in the incoming feed stream.

The precipitation of the copper sulphide solids in step b) may be conducted at an operating temperature is between approximately 5 and 95 degrees Celsius.

The operating temperature may be between 15 and 80 degrees Celsius, and preferably is between about 20 and about 50 degrees Celsius.

The residence time may be between about 0.5 and about 4 hours.

The residence time may be less than 2.5 hours.

The residence time may be 2 hours.

The precipitation of the copper sulphide solids in step b) may be conducted at a solution pH that is less than 4.

The solution pH may be between about 0.5 and 3, and preferably may be about 1.5.

Processing the copper-depleted stream to separate the precipitated copper sulphide solids includes using a solid/liquid separator.

The solid/liquid separator may include a separation apparatus having a filter, and wherein the copper sulphide slurry may form a filter cake on the filter and the output stream comprises filtrate passing through the filter.

A copper concentration in the feed stream is between about 1 to 6 g/L or about 2 to 5 g/L and wherein a copper concentration in the copper-depleted stream is between about 5 and 50 mg/L.

At least 99% wt of the copper present in the incoming feed stream may be precipitated in step b)

The method may include, prior to step a): a) receiving a black mass feed material comprising at least lithium, copper, and graphite liberated from within battery materials via a physical disassembly process, the black mass feed material has a first concentration of lithium and a first concentration of copper; b) acid leaching the black mass material at a pH that is less than 4, thereby producing a pregnant leach solution (PLS) comprising less graphite than the black mass feed material, at least 80% of the lithium and the copper from the black mass feed material, the PLS having a second concentration of lithium that is greater than the first concentration of lithium and a second concentration of copper that is greater than the first concentration of copper, wherein the incoming feed stream comprises the PLS.

The feed stream may include cadmium, and wherein step b) may include precipitating cadmium sulphide solids out of the feed stream during the precipitation residence time, and wherein step c) comprises separating the precipitated cadmium sulphide solids from the copper sulphide slurry.

In accordance with another broad aspect of the teachings described herein, a method of processing an incoming feed stream containing at least one target metal liberated from within battery materials via sulphide precipitation, the at least one target metal comprising at least one of copper, cadmium, cobalt, iron and nickel and graphite, may include the steps of: a) receiving an incoming feed stream comprising the at least one target metal entrained in a carrier liquid in a precipitation apparatus; b) introducing a sulphide reductant to the feed stream to precipitate at least target metal sulphide solids out of the feed stream during a precipitation residence time that is less than 24 hours to produce a target metal sulphide slurry; and c) processing the target metal sulphide slurry to separate at least the precipitated target metal sulphide solids and provide a target metal-depleted stream.

The method may also include prior to step a), a) receiving a black mass feed material comprising the at least one target metal liberated from within the battery materials via a physical disassembly process, the black mass material having a first concentration of the at least one target metal; and b) acid leaching the black mass material at a pH that is less than 4, thereby producing a pregnant leach solution (PLS) comprising less graphite than the black mass feed material, at least 80% of the lithium and the copper from the black mass feed material, the PLS having a second concentration of the at least one target metal that is greater than the first concentration, wherein the incoming feed stream comprises the PLS.

At least 99% wt of the at least one target metal present in the incoming feed stream may be precipitated in step b).

The reductant may be added to the incoming feed stream in step b) to reduce the oxidation reduction potential (ORP) of the target metal sulphide slurry to between 0 mV and −200 mV.

The method may include after step c) the step of oxidizing the copper-depleted stream downstream from the precipitation apparatus to increase the ORP of the target metal-depleted stream.

The method may include adjusting the ORP of the target metal-depleted stream to be equal to or above 400 mV by introducing an oxidant into the target metal-depleted stream.

The ORP may be about 500 mV.

Adjusting the ORP of the target metal-depleted stream may include introducing at least one of oxygen gas, hydrogen peroxide, and perchloric acid.

The sulphide reductant may include at least one of sodium sulphide, sodium hydrosulphide, and hydrogen sulphide.

The sulphide reductant may include sodium hydrosulphide.

The precipitation of the target metal sulphide solids in step 26b) may be conducted at an operating temperature is between approximately 5 and 95 degrees Celsius.

The operating temperature may be between 15 and 80 degrees Celsius, and preferably is about 20 and about 50 degrees Celsius.

The precipitation of the copper sulphide solids in step b) may be conducted at a solution pH that is less than 4.

The solution pH may be between about 0.5 and 3, and preferably is about 1.5.

The at least one target metal may include cobalt and step b) may include precipitating cobalt sulphide solids out of the feed stream.

The at least one target metal may include cadmium, and step b) may include precipitating cadmium sulphide solids out of the feed stream.

The at least one target metal may include copper and step b) may include precipitating copper sulphide solids out of the feed stream.

The feed stream further may include graphite and lithium, and wherein the target metal-depleted stream may include the lithium.

The sulphide reductant may be introduced so that it has a molar concentration within the feed stream of between 1.2 and 1.6 times the molar concentration of the at least one target metal in the incoming feed stream.

The sulphide reductant may be introduced so that it has a molar concentration within the feed stream of between 1.4 and 1.5 times the molar concentration of the at least one target metal in the incoming feed stream, and preferably so that it has a molar concentration within the feed stream of between 1.4 and 1.45 times the molar concentration of the at least one target metal in the incoming feed stream.

The at least one target metal may include copper and cadmium, and wherein the sulphide reductant may be introduced so that it has a molar concentration within the feed stream of between 1.4 and 1.5 times the sum of the molar concentration of the copper and the cadmium in the incoming feed stream.

Other advantages of the invention will become apparent to those of skill in the art upon reviewing the present specification.

### BRIEF DESCRIPTION OF THE DRAWINGS

Embodiments of the present invention will be described with reference to the accompanying drawings, wherein like reference numerals denote like parts, and in which:

FIG. 1 is one example of a method of precipitating copper sulphide from an incoming feed stream;

FIG. 2 is a schematic representation of one example of a system that can be used in a method of precipitating copper sulphide from an incoming feed stream; and

FIG. 3 is a detailed schematic representation of a portion of the system of FIG. 2.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors, or owners do not intend to abandon, disclaim, or dedicate to the public any such invention by its disclosure in this document.

Lithium-ion batteries are a type of rechargeable battery in which lithium ions drive an electrochemical reaction. Lithium has a high electrochemical potential and a high energy density. Lithium-ion battery cells have four key components: a. Positive electrode/cathode: including differing formulations of metal oxides or metal phosphate depending on battery application and manufacturer, intercalated on a cathode backing foil/current collector (e.g. aluminum)—for example: LiNixMnyCOzO2 (NMC); LiCoO2(LCO); LiFePO4 (LFP); LiMn2O4 (LMO); LiNiCoAlO2 (NCA); b. Negative electrode/anode: generally, comprises graphite intercalated on an anode backing foil/current collector (e.g. copper); c. Electrolyte: for example, lithium hexafluorophosphate (LiPF6), lithium tetrafluoroborate (LiBF4), lithium perchlorate (LiClO4), lithium hexafluoroarsenate monohydrate (LiAsF6·H₂O), lithium trifluoromethanesulfonate (LiCF3SO3), lithium bis(bistrifluoromethanesulphonyl) (LiC₂F₆NO₄S₂), lithium organoborates, or lithium fluoroalkylphosphates dissolved in an organic solvent (e.g., mixtures of alkyl carbonates, e.g. C1-C6 alkyl carbonates such as ethylene carbonate (EC, generally required as part of the mixture for sufficient negative electrode/anode passivation), ethyl methyl carbonate (EMC), dimethyl carbonate (DMC), diethyl carbonate (DEC), propylene carbonate (PC)); and d. Separator between the cathode and anode: for example, polymer or ceramic based.

As noted above, “black mass”, as used herein refers a combination of cathode and/or anode electrode powders from lithium-ion batteries. The chemical composition of black mass various based on the battery type and composition being processes. Lithium cathode and anode (graphite) powders are expected to be the primarily components of black mass. Other materials will also be present in black mass, including, residual organic electrolyte (e.g. C1-C6 alkyl carbonates, such as ethylene carbonate (EC), ethyl methyl carbonate (EMC), dimethyl carbonate (DMC), diethyl carbonate (DEC), propylene carbonate (PC), and mixtures thereof), iron, aluminum, cadmium, cobalt, nickel, copper, plastics possibly iron and phosphorous if the batteries include LFP batteries.

The systems and processes for obtaining the black mass from batteries can generally include one or more suitable, size reduction operations in which incoming batteries in the form of whole batteries, cells and/or portions thereof, along with any associated leads, housings, wires and the like (collectively referred to as battery materials) are at least physically processed to liberate the black mass materials within the battery cell for further processing. This can include physically shredding the incoming battery materials, such as using a suitable comminuting apparatus, in an operation that can break open the battery cells and can convert the incoming battery materials into a plurality of relatively small, size-reduced battery materials that can be further processed. The black mass material, and some other materials, can be formed into a slurry that travels downstream from the comminuting apparatus, and is optionally subjected to one or more separation or further processing steps to help separate the various materials present in the slurry into one or more relatively pure product streams. For example, further processing, if appropriate, can include using one or more suitable process steps and/or apparatuses including washing, screening, filtering, leaching and the like to separate the desired black mass product material (including one or more potentially valuable, target metals) from the other materials (such as plastics, other metals, other packaging materials, at least a portion of the electrolyte and other such materials). The desired black mass materials can contain the outputs/products from these processing steps. As such, the input for the sulphide separation techniques and systems described herein can be a feed stream that includes a slurry having various elements coming from the size reduction process, or a further processed material such as a pregnant leach solution, or optionally another process stream that can be created using a suitable technique and that is suitable for processing via the sulphide precipitation processes described herein. For the purposes of the teachings here, the feed stream that is processed using the described techniques can be a slurry, a pregnant leach solution or other stream that contains at least some of the desired target metals that have been obtained/liberated from battery materials or that have been obtained from other sources.

For example, the inventors have developed a method of processing an incoming feed stream that contains one or more target metals, such as copper, lithium, cadmium, cobalt, iron and/or nickel and others, and preferably may include black mass material that is derived from batteries (including from lithium-ion batteries), whether obtained by the processes described herein or via other suitable processes.

The methods described herein may be a method for precipitating a target metal from the incoming feed stream to provide precipitated target metal sulphide solids. For example, one embodiment of the teachings herein may be a method for precipitating copper sulphide from the incoming feed stream that includes copper, and possibly other materials. In another example, the method may be used to precipitate iron, or cadmium or cobalt or other such target materials from the feed stream and may or may not also include precipitating copper. These methods may help recover at least a commercially relevant portion of the copper, or other target metal such as cadmium, cobalt, or nickel, from the incoming feed stream material. The systems described herein may be used to perform the described methods.

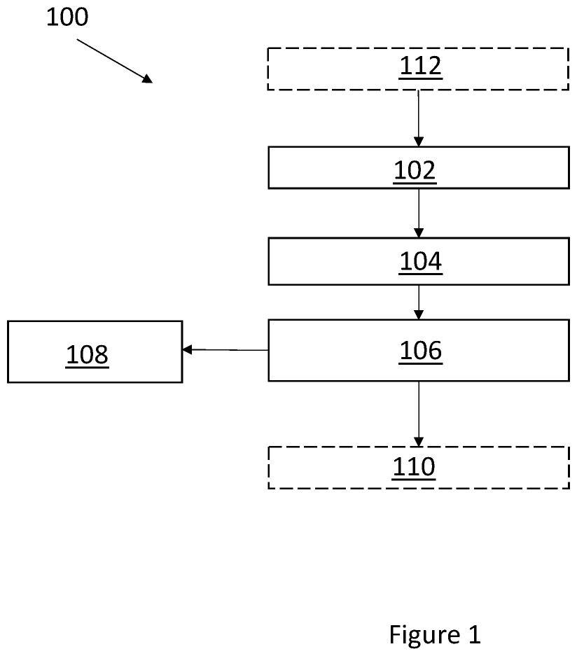

Referring to FIG. 1, one example of a method 100 includes, at step 102, receiving an incoming feed stream that contains black mass material, preferably including at least copper and lithium (and optionally including any combination of the black mass materials described herein) that is entrained in a suitable carrier liquid (such as water, process liquids from an upstream process step such as a pregnant leach slurry, a comminuting immersion liquid—possibly including entrained electrolyte materials liberated from the batteries during size reduction, and the like). The black mass material may be created/produced using any suitable technique and may be received in the form of a filtered product with at least some degree of residual moisture that is the output of upstream battery shredding/processing operations. Preferably, the feed stream in this example is a pregnant leach solution as described herein, but may have different compositions and configurations in other examples.

If the black mass material is derived from lithium-ion batteries it may have different components, and the black mass materials that may be treated using the methods described herein may include at least 1.5%, 2%, 2.5%, 3%, 3.5%, 4%, 4.5%, 5% wt lithium, and will likely have less than about 10% wt lithium in most examples. In some examples black mass may preferably have about 3% wt lithium. Similarly, the black mass may include at least 2% wt copper, 0.1% wt cadmium, 5% wt cobalt, and 20 to 35% wt nickel.

The feed stream can be received in any suitable processes apparatus, such as a precipitation apparatus, that can include one or more suitable vessels or tanks, solid/liquid separators, pumps, controllers, flow control devices, settling tanks, suitable containment and ventilation systems, and under suitable residence times and operating conditions and the like. Generally, as used herein, the precipitation apparatus can include any suitable combination of physical tanks, vessels and the like.

Having received the incoming slurry in the precipitation apparatus, the method can advance to step 104 in which a suitable sulphide reductant is introduced into the feed stream to help facilitate the precipitation of at least copper sulphide solids, and optionally other target metal sulphide solids, out of the feed stream by holding the slurry and reductant for a precipitation residence time that is less than 24 hours.

That is, the inventors have discovered that relevant target metals such as copper or cadmium may be separated from the feed stream via a sulphide precipitation process, instead of, for example, a solvent extraction process or a cementing process. This may help reduce the complexity and/or capital and operating costs of an overall battery recycling process (or the like), as compared to using a comparable solvent extraction process.

For example, the inventors have developed a process by which a sulphide, such as sodium hydrosulphide (NaHS) or sodium sulphide (Na₂S), hydrogen sulphide (H₂S) (amongst others) could be used as a reductant to help precipitate a variety of metal-sulphides in accordance with the following, exemplary, reactions:

Cu(SO₄)+Na₂S=CuS+Na₂(SO₄)

Cd(SO₄)+Na₂S=CdS+Na₂(SO₄)

Co(SO₄)+Na₂S=CoS+Na₂(SO₄)

Ni(SO₄)+Na₂S=NiS+Na₂(SO₄)

When the precipitation process has run for its desired time and under the desired conditions (including those as described herein), and/or reached its desired level of precipitation efficiency, the material within the precipitation apparatus at the end of step 104 can be described as a copper sulphide slurry or more generally as a target metal sulphide slurry in examples where other metals are precipitated (such as a cadmium sulphide slurry, cobalt sulphide slurry, nickel sulphide slurry or the like). That is, if other target materials are also present in the feed stream, such that other metal sulphide solids also precipitated out of solution along with the copper, it is possible that the slurry created at the end of step 104 will include precipitates other than copper-based precipitates, but for the purposes of the teachings herein it can still be referred to as a copper sulphide slurry for convenience. That is, the copper sulphide slurry described herein need not be limited to only/exclusively including copper sulphide solids and it may contain a mixture of different solids.

Following step 104, the method 100 can proceed to step 106 that includes processing the copper sulphide slurry to separate at least some, and preferably substantially all of the precipitated copper sulphide solids (and other target metal sulphide solids) from the copper sulphide slurry. For example, step 106 can include treating the copper sulphide slurry using a suitable solid/liquid separator, such as a filter, to collect the metal sulphide solids as a filter cake material while allowing a now copper-depleted filtrate to pass through the filter and to form a copper-depleted stream. Preferably, the copper-depleted filtrate stream will include at least most, if not substantially all of the lithium that was present in the incoming black mass feed stream so that it can be recovered in later processing steps. More generally, a target metal-depleted stream can be produced using a variety of suitable techniques for separating the target metal sulphide solids from the associated slurry.

Based on testing that has been conducted by the Applicant and of which representative results are summarized herein, it is believed that the methods for sulphide precipitation 100 described herein may be conducted with a residence time that is less than 24 hours, and preferably can be between about 0.5 and about 4 hours, and more preferably is less than about 2.5 hours, and may be about 2 hours.

The operating temperature of the slurry at step 106 as the precipitation is occurring is preferably between approximately 5 and 95 degrees Celsius, and may be conducted at between 15 and 80 degrees Celsius, and preferably is between about 20 and about 50 degrees Celsius.

The pH of the solution in the precipitation apparatus at step 106 is preferably set to be less than 4, and more preferably is adjusted to be between approximately 0-4. In some preferred examples, the pH may be between about 0.5 and 3 during step 106, and may, in some examples, be adjusted to be about 1.5 during step 106.

This precipitation process can be conducted such that the oxidation reduction potential (ORP) of the filtrate solution that is produced at the end of the process (which may also be referred to as the copper-depleted PLS which forms the first material solution in some of the present examples) may be at a precipitation ORP target range that is between about −200 mV and about 0 mV, and in some examples may be greater than about −100 mV and may be approximately −50 mV.

The amount of the sulphide reductant that is used in process 100 can be selected based on a variety of suitable factors/criteria. The sulphide reductant material may be added into the process in any suitable form, and may be added as a solid or powder or alternatively may be pre-mixed into a suitable reductant solution that includes a desired concentration of the active sulphide reductant material. For example, for examples in which the reagents include sodium sulphide (Na₂S) and/or sodium hydrosulphide (NaHS), the process can be configured such that the sulphide reductant is introduced via a reductant solution and has a concentration in the solution is between about 5-20%, and preferably may be around 10% wt. That is, in some examples sodium hydrosulphide may be first provided as a solid in bulk bags that is then used to create a suitable reductant solution of sodium hydrosulphide by mixing the solids with water, thereby forming a solution of sodium hydrosulphide containing 5 to 20% wt, and optionally about 10% wt of the reagent in solution. The reductants can also be added so that excess sulphide is provided, such as between about 1.2-1.6×, and optionally between about 1.4-1.5× or between about 1.41-1.44×, the stoichiometric concentration of the target metals (such as copper in examples where copper only is being targeted, the sum of the stoichiometric concentration copper & cadmium in examples where copper and cadmium are being targeted, etc.) in the incoming slurry.

Testing of this method 100 conducted by the applicant indicates that a copper precipitation efficiency of over 99%, and in some conditions of about 99.9% can be achieved using these methods and parameters described herein.

Having been processed/separated, the separated solids can be further processed at step 108, such as by drying and/or packaging the metal sulphide solids for sale or other commercial uses. The copper-depleted, but generally lithium-rich stream can be sent for further processing via an optional step 110 by which other target materials, including lithium and/or gypsum, may be extracted from the filtrate stream. Some examples of suitable systems and separation processes that can be used to help separate at least the lithium from the filtrate stream, at step 110, can include those used by and available from Li-Cycle Corp. (of Toronto, Canada) and are described in international patent publication no. WO2018/218358 entitled A Process, Apparatus, And System For Recovering Materials From Batteries and U.S. provisional patent application No. 63/122,757 entitled System And Method For Processing Solid State Or Primary Lithium Batteries, a U.S. provisional patent application filed by Li-Cycle Corp. and entitled System And Method For Recovering Plastic From Battery Materials, and international patent application no. PCT/CA2021/050266 entitled A Method for Processing Lithium Iron Phosphate Batteries, each of which are incorporated herein by reference

Optionally, in addition to such post-processing steps the process 100 may include, prior to step 102, an optional pre-processing step 112 in which incoming batteries and battery materials can be processed, using one or more sub-steps and a variety of suitable systems and apparatuses, to provide a material stream that has the desired attributes and can be used as the incoming feed stream that is received at step 102.

For example, the pre-processing step 112 can include the use of a size-reduction apparatus or comminuting apparatus (such as the system 500 and apparatus 502 described herein) that can help to cause a size reduction of the incoming battery materials to form reduced-size battery materials and to liberate electrolyte materials and a black mass material comprising anode and cathode powders from within the battery materials. In some examples, the incoming black mass material, or other feed stream materials, can be in different states based on the particulars of a given treatment method, and optionally the processes described herein can generally include the steps of receiving a suitable input black mass material obtained as part of a suitable, upstream separation process. Optionally, black mass can be received as a filtered solid with residual moisture or a flowable slurry. Optionally, the black mass material may be treated or conditioned to help make it more suitable for the processes described herein. For example, if black mass is received as a filtered solid, it can be re-slurried to form a flowable slurry that has a desired pulp density, such as a pulp density between 15 and 35% wt, using water or other suitable solvents. When black mass is received as a flowable slurry, water may be added to achieve a suitable and/or desired pulp density, such as between about 15 and about 35% wt.

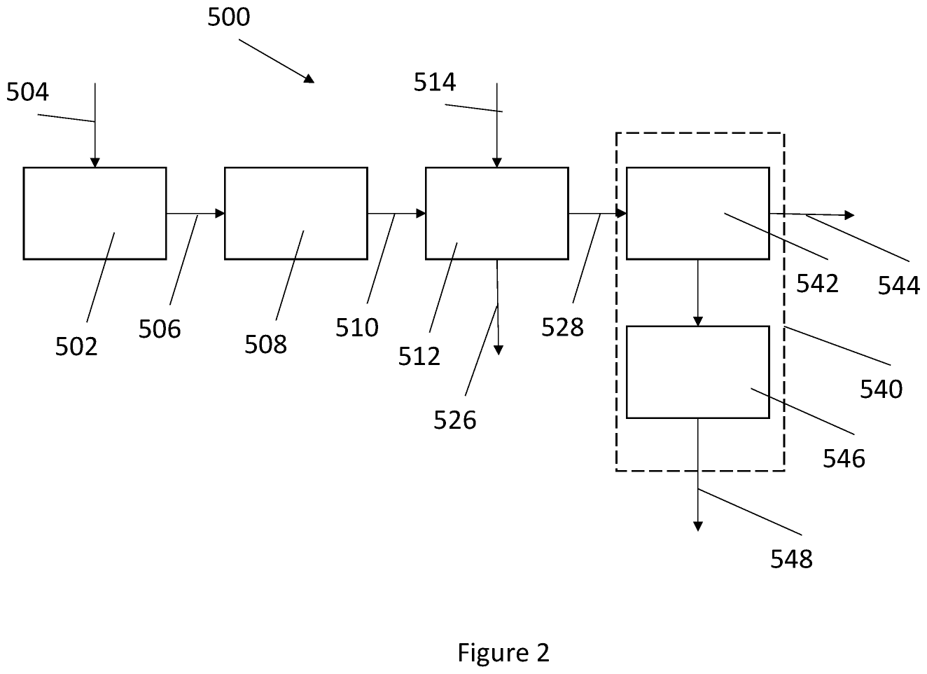

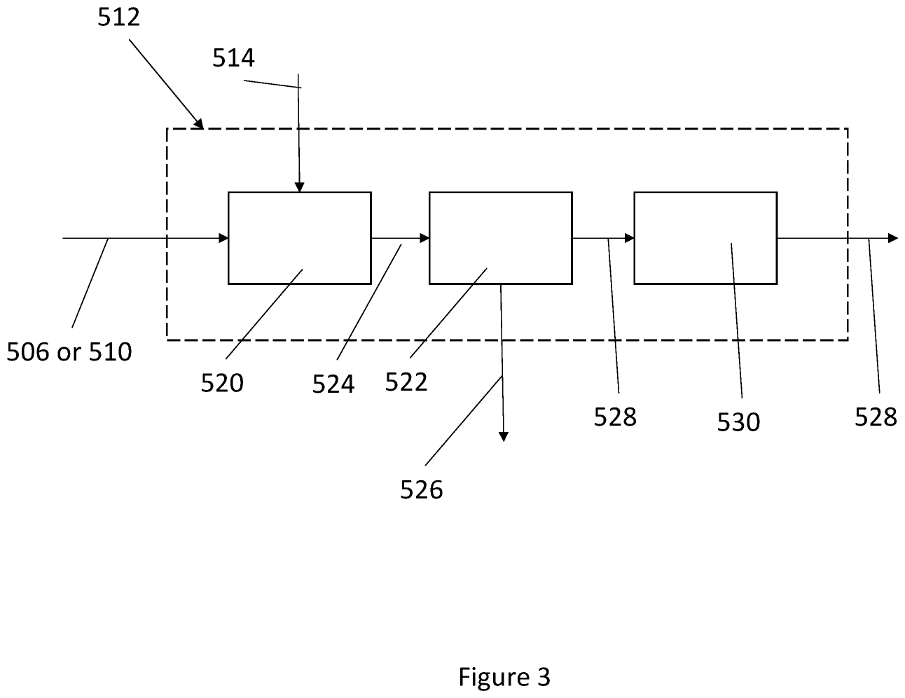

Referring to FIGS. 2 and 3, a schematic representation of a system 500 that can be used to perform the method 100 includes a primary size-reduction apparatus 102 that is configured to receive incoming batteries and/or battery materials 504 and conduct at least one size-reduction process. One example of a suitable apparatus that can be used as part of the apparatus 502 can be described as an immersion comminuting apparatus that can include a housing that has at least one battery inlet through which battery materials can be introduced into the housing.

The size-reduction apparatus 502 preferably has at least a first, submergible comminuting device that can be disposed within the housing and is preferably configured to cause a first or primary size reduction of the battery materials to form reduced-size battery materials (which can include a mixture of size-reduced plastic material, size-reduced metal material and other materials) and to help liberate anode materials and cathode materials and other metals from within the battery materials.

The size-reduction apparatus may include two or more separate comminuting apparatuses in some examples, and each immersion comminuting apparatus may itself have one, two or more submerged comminuting devices contained therein and arranged in series, such that the size-reduction apparatus may include two or more size-reduction steps in series, and may allow for intervening process steps between the size-reduction steps. For the purposes of the teachings herein, and for distinguishing between the secondary size-reduction that is performed on the plastics slurry/stream as described herein, the overall operations of the first, or primary size-reduction apparatus can be described as a first or primary size reduction process, where generally raw or unprocessed incoming battery materials can enter the immersion comminuting apparatus 502 and then one or more streams of size-reduced material that are sent to other process steps are obtained. The content of these post-size reduction materials can be described has having size-reduced or primary-reduced materials (i.e. fragments of the incoming battery materials) regardless of the number of internal size-reduction steps are employed in the immersion comminuting apparatus 502.

For example, an immersion comminuting apparatus 502 with a single shredding stage can receive incoming battery materials 504, conduct at least a first size reduction and produce primary-reduced materials that are sent for further processing. Similarly, an immersion comminuting apparatus 502 that includes two separate immersion comminuting apparatuses arranged in series (each with at least one submerged comminuting device) and with some product take-off streams between them can also be described as receiving the incoming battery materials, conducting at least a first size reduction process and producing primary-reduced materials for the purposes of the teachings herein.

The immersion material, preferably an immersion liquid (but optionally a granular solid in some examples), may be provided within the housing of the immersion comminuting apparatus and preferably is configured to submerge at least the first comminuting device, and optionally may also cover at least some of the battery materials. The first size reduction of the battery materials using this apparatus can thereby be conducted under the immersion material (and under immersion conditions) whereby the presence of oxygen is suppressed, absorption of heat and the chemical treatment of electrolyte by the immersion liquid. This may also cause the electrolyte materials, the black mass material and the reduced-size plastic and metal materials to become at least partially entrained within the immersion liquid to form a blended material or slurry, which can be extracted from the immersion comminuting apparatus 502.

For example, the immersion comminuting apparatus 502 is preferably configured so that it can produce at least a metals slurry that includes the black mass material and other materials, such as copper and aluminium foils, can be withdrawn via at least one non-plastic or metals recovery stream 506. This can allow the plastic material to be processed generally separately from the metal or other non-plastic materials.

The sized-reduced battery materials exiting the immersion comminuting apparatus 502, in stream 506, may be fed directly into a suitable precipitation apparatus and may form the input slurry for step 102 in the methods described herein. Alternatively, as illustrated schematically in FIG. 2, the extracted metals recovery stream 506 can then be further processed, if appropriate, using one or more suitable process steps and/or apparatuses including washing, screening, filtering, leaching and the like to separate the desired black mass product material from the other materials (such as plastics, other metals, other packaging materials, at least a portion of the electrolyte and other such materials). The desired black mass materials can be obtained as one of the outputs/products from the separation apparatus.

For example, the exemplary system 500 includes an optional processing system 508 that can receive the metals stream 506 and process it to produce a conditioned material stream that is relatively rich in copper, and possibly other target metals (including cobalt, nickel and others described herein), as compared to the composition of the untreated metals stream 506, and also contains quantities of lithium, aluminum, graphite and other materials. The composition of this conditioned material stream 510 that exits the processing system 508, may vary based on the type of treatment process that is used, even if processing the same incoming black mass material.

Preferably, the processing system 508 may include the hardware suitable for at least partially leaching the metals stream 506 so that a conditioned material stream 510 in the form of a pregnant leach solution (PLS) is provided. For example, the black mass material may be leached using suitable reagents (such as sulfuric acid or other acids, hydrogen peroxide, oxygen and a combination thereof and other reagents) to generate the PLS. At the conclusion of the leaching step the resulting stream can be filtered to separate the unwanted residues and solids, which may include at least a portion of any graphite that was in the black mass material, anode and/or cathode binder (PVDF), residual solid cathode and the like, and produce a pregnant leach solution that is relatively rich in at least lithium and copper amongst other minor components and/or solvents and that is the conditioned material stream 510 in this example. The processing system 508 is preferably configured so that the conditioned material stream 510 (e.g. the PLS in this example) is relatively more suitable for further processing via the method 100 and systems described herein than the native pre-processed metals stream 506 would have been.

In such examples, the incoming feed stream that is received in step 102 may include the conditioned material stream 510, rather than—or as a mixture with, the metals stream 506. In the illustrated example system 500, the conditioned material stream 510 forms the input feed stream for the sulphide precipitation processes. In other examples, the input feed stream may include the metals stream 506 either alone, or in combination with other material inputs, but without requiring the use of the optional processing system 508.

To conduct the sulphide precipitation methods described herein, the system 500 includes a schematic representation of a precipitation apparatus 512 that receives the incoming feed material stream (optionally the metal slurry 506, the conditioned material stream 510 or from another suitable source) and can also receive a supply of the desired sulphide reductant 514. The precipitation apparatus 512 can include any suitable combination of hardware (including tanks, vessels, conduits, flow control hardware or the like), including as described herein. Referring to FIG. 3, in one schematic representation the precipitation apparatus 512 includes a primary precipitation vessel 520 that can receive the incoming feed material slurry 506 or 510 (or other) and the sulphide reductant 514. This vessel 520 can be a tank or other suitable vessel that can be operated at the conditions described herein, and can include any suitable agitators, valves, pumps, spargers and other flow control devices. It can be controlled via a suitable controller (such as a computer, PLC or the like).

A solid/liquid separator 522 is, in this example, provided downstream from the precipitation vessel 520 and can receive the copper sulphide slurry 524. In this example the separator 522 can be a filter press, and the separated metal sulphide solids can be extracted via a solids stream 526, while the now copper-depleted stream 528 can be sent for further processing. The copper-depleted stream 528 can be held in an optional storage tank 530 until needed, and can then exit the precipitation apparatus 512 as the copper-depleted stream 528.

Referring again to FIG. 2, the copper-depleted stream 528 can be sent for further processing via a downstream hydrometallurgical processing system 540 can include any suitable processes and systems, including leaching, precipitation, filters and other operations that can help separate and extract the various target products, including utilizing the processes and systems described in in PCT patent publication no. WO2018/218358, U.S. Provisional Patent Application No. 63/122,757, and PCT patent application no. PCT/CA2021/050266, each of which are incorporated herein by reference.

In this schematic illustration, the downstream hydrometallurgical processing system 540 can include a gypsum separation system 542 via which the copper-depleted stream 528 can be processed to remove gypsum that may be contained in the copper-depleted stream 528. This may include the steps of adjusting the oxidation reduction potential (ORP) of the copper-depleted stream 528 to help make it more suitable for a downstream process, such as gypsum recovery. For example, in some examples of the processes described herein the copper-depleted stream 528 may have an ORP of between −200 mV and about 0 mV, and step 110 can include adjusting the ORP of the copper-depleted stream comprises introducing at least one of oxygen gas, hydrogen peroxide, and perchloric acid. Preferably, this can include increasing the ORP of the copper-depleted stream 528 to be equal to or above 400 mV, and preferably to be about 500 mV which converts Fe2+ in the solution to Fe3+, which can help facilitate the downstream separation of iron from other target metals (such as cobalt and nickel, for example) and may help facilitate other downstream processing steps, via stream 544, or other materials from copper-depleted stream 528. Other suitable separation systems 546 can be used to further process the process slurries and material streams and can be configured to recover at least the target lithium metal as a lithium output stream 548. Optionally, the monitoring and adjusting of the ORP during the precipitation process can be used as a control or feedback mechanism to help regulate the supply of the reductant material. For example, in some examples, the conditions within the precipitation apparatus can be monitored using a suitable sensor/monitor so that reductant is added along with the incoming feed stream to reduce the ORP of the copper sulphide slurry within the precipitation apparatus to a target range that is between about 0 mV and about −200 mV. As the process is underway the ORP of the slurry can be monitored and the amount of reductant added (and/or the rate of its addition) can be adjusted in real time to help keep the ORP within the desired target range.

The immersion liquid used in the described embodiments may be basic and is preferably at least electrically conductive to help absorb/dissipate any residual electric charge from the incoming battery materials. The immersion liquid may be selected such that it reacts with lithium salt (such as LiPF₆) that may be produced via the liberation of the electrolyte materials during the size reduction process, whereby the evolution of hydrogen fluoride during the size reduction is inhibited. The immersion liquid within the housing of the primary immersion apparatus 102 may preferably be at an operating temperature that is less than 70 degrees Celsius to inhibit chemical reactions between the electrolyte materials and the immersion liquid, and optionally the operating temperature may be less than 60 degrees Celsius. The immersion comminuting apparatus can be configured so that the immersion liquid is at substantially atmospheric pressure (i.e. less than about 1.5 bar) when the system is in use, which can simplify the design and operation of the apparatus.

In some examples, the immersion liquid may be at least one of water and an aqueous solution. The immersion liquid may have a pH that is greater than or equal to 8, and optionally may include at least one of sodium hydroxide and calcium hydroxide. The immersion liquid may include a salt, whereby the immersion liquid is electrically conductive to help at least partially dissipate a residual electrical charge within the battery materials that is released during the size reduction. The salt may include at least one of sodium hydroxide and calcium hydroxide.

Particles that are liberated from the battery materials by the comminuting apparatus 502 during the first size reduction may be captured and entrained within the immersion liquid and may be inhibited from escaping the housing into the surrounding atmosphere. The first comminuting device may be configured as a shredder that is configured to cause size reduction of the battery materials by at least one of compression and shearing. The black mass material obtained using these processes, including at least some residual amounts of the immersion liquid and any electrolytes entrained therein can form the black mass feed materials as described herein.

Testing was conducted in accordance with at least some of the embodiments described herein and has demonstrated that the processes and operating ranges described herein can provide useful results. A brief description of some exemplary, representative tests is included below.

A first test example of the described treatment processes was performed to validate a first example of processes described herein. In this first example, Lithium iron phosphate (LFP) black mass was generated using a size reduction process on LFP batteries. The black mass used in this example had a composition of approximately 2.1% wt lithium (Li), 15.3% wt iron (Fe) and 7.8% wt phosphorus (P). A selective leaching process was conducted with a pulp density of 20% wt in sulfuric acid (H₂SO₄) for a residence time of approximately 4 hours at an operating temperature of approximately 60° C. The leach solution in this test was maintained at a pH of 2.0 via addition of H₂SO₄ over the course of the reaction/residence time. Additionally, an oxidant, in this case oxygen gas (O₂), was sparged into the leach at a rate of 1.5 L/min over the course of the leaching process. The resulting pregnant leach solution (PLS) was separated from the residue using a Buchner funnel with a Whatman® grade 3 filter paper attached to a vacuum flask. Testing of the outputs of this process revealed a leaching efficiency of approximately 87.7% for Li, 22.9% for Fe, 0.9% for P and 94.9% for Cu with concentrations of 3.4 g/L, 3.8 g/L, 0.2 g/L and 6.2 g/L respectively in the PLS.

The PLS was then processed using method 100 as described herein, where a sulphide reductant, in this case sodium hydrosulphide (NaHS) as a 20% wt NaHS solution, was added to precipitate copper sulphide as a solid from the PLS (in accordance with step 106 herein). The NaHS was added to help reduce the oxidation-reduction potential (ORP) of the PLS to about −50 mV at 20° C. The solution was separated from the precipitate using a Buchner funnel with a Whatman® grade 3 filter paper attached to a vacuum flask. In this process 99.9% of Cu deported to solids.

In another set of experiments, a series of tests were conducted on two different test slurries. The slurries were created by performing a size reduction on some sample lithium-ion battery materials (such as by using a size-reduction apparatus 502) to create a black mass material slurry that contained a mixture of metals and other components liberated from the battery materials. The black mass material slurries were then further processed by leaching the slurries using a processing system 508 and in accordance with the processes described in international patent publication no. WO2018/218358 entitled A Process, Apparatus, And System For Recovering Materials From Batteries (incorporated herein by reference) to provide a pregnant leach solution (PLS). To compare the behaviour of slurries having different copper concentrations, relative to the other metals present in the PLS, some of the PLS was further processed using a known, solvent extraction process (such as the processes described in international patent publication no. WO2018/218358 entitled A Process, Apparatus, And System For Recovering Materials From Batteries) to remove copper from the PLS and produce substantially “copper-free” PLS samples referred to herein as raffinate. 45 different tests were conducted. In some tests, the raffinate (e.g. copper-free PLS) was used with Na₂S to precipitate CdS while the remaining tests used PLS with copper and Na₂S or NaHS to precipitate both CdS and CuS according to the reactions described herein.

The initial concentrations of elements in the PLS used in these experiments are shown in Table 1. The specified reagent was added to a beaker of PLS over the duration specified in solid or solution form as indicated. The experimental included a beaker with PLS, pH probe and meter, stir plate, stir bar, graduated cylinder for reagent and peristaltic pump for reagent addition. In cases where low reagent volume or more rapid addition were required, the reagent was added by pipette. In these test cases the reaction/precipitation residence time spanned 30-120 minutes with the process being conducted as indicated in Table 3. The process is defined by the order in which the procedure was conducted with respect to pH, temperature adjustments, reagent addition and use of filtration with pH 4 DI water.

TABLE 1
PLS initial concentrations

| | [Al] | [Cd] | [Co] | [Cu] | [Fe] | [Li] | [Mn] | [Na] | [Ni] |
|---|---|---|---|---|---|---|---|---|---|
| Sample | mg/L | mg/L | mg/L | mg/L | mg/L | mg/L | mg/L | mg/L | mg/L |
| PLS | 4525 | 975 | 14480 | 5135 | 3630 | 5560 | 8200 | 97.6 | 20470 |

In each test, filtrate, wash water and solids samples were taken to analyze the concentration of elements in each and complete a mass balance. The sum of the concentration of each element in the liquids (filtrate and wash water) and volume is used to calculate a removal efficiency or loss relative to the initial mass in the respective PLS; these results are shown in Table 2.

TABLE 2
Test removal efficiencies and losses based on liquid concentrations

| | Cd Re- | Cu Re- | Co | Ni | Mn | Al | Fe | Li |
|---|---|---|---|---|---|---|---|---|
| | moval | moval | Loss | Loss | Loss | Loss | Loss | Loss |
| Test # | (%) | (%) | (%) | (%) | (%) | (%) | (%) | (%) |
| CSP-10 | 97 | 100 | 3 | 0 | 0 | 3 | 0 | 0 |
| CSP-43 | 100 | 100 | 31 | 30 | 0 | 89 | 94 | 24 |
| CSP-44 | 85 | 99 | 9 | 7 | 7 | 11 | 1 | 12 |
| CSP-45 | 86 | 97 | 12 | 10 | 10 | 14 | 5 | 15 |

Initial testing of the raffinate solution revealed that precipitation with Na₂S was able to remove cadmium while also removing copper, however losses of other elements were relatively significant. Testing was conducted on approximately 45 different feed solutions, under different operating conditions and using different reductants as described herein. The most effective test results are summarized in Table 2 were determined as being tests CSP-10 and CSP-43-45.

TABLE 3
Test Conditions for Precipitation Testing

| | Feed | | Precipita- | Stoichi- | Temp | Residence | |
|---|---|---|---|---|---|---|---|
| Test # | Solution | pH | tion agent | ometry | (C.) | Time | |
| CSP-10 | PLS | 3.0 | Na₂S•9H₂O | 2.0 × | 20 | 2 | hours |
| | | | | [Cu + Cd] | | | |
| CSP-43 | PLS | 1.0 | NaHS | 1.41 × | 20 | 30 | min |
| | | | | [Cu + Cd] | | | |
| CSP-44 | PLS | 0.5 | NaHS | 1.44 × | 20 | 30 | min |
| | | | | [Cu + Cd] | | | |
| CSP-45 | PLS | 0.5 | NaHS | 1.42 × | 20 | 30 | min |
| | | | | [Cu + Cd] | | | |

In test 10, 2×[Cu+Cd] Na₂S, room temperature with pH 3 PLS, the loss of desirable elements was reduced while cadmium removal resulted in 13 mg/L cadmium remaining in the PLS solution and 37 mg/L in the wash water. Testing was continued however to achieve a PLS concentration less than 10 mg/L. The cadmium sulphide precipitation stage of test 45 which was conducted using 1.41×[Cu+Cd] stoichiometric excess of NaHS, in 2 minutes of addition with a 30 minute residence time and PLS with no pH adjustment resulted in a substantially complete removal of cadmium and copper with a concentration of 12860 mg Co/L (89%) remaining in solution. This was among the greatest concentrations remaining in solution while the following stages of oxidation reduction potential (ORP) and pH adjustment resulted in a final removal of 31% in solution and 16% as measured from the solids mass balance. It was observed that providing the volume of NaSH required to obtain an ORP of approximately −40 mV was sufficient to achieve complete removal of cadmium, as seen in test 43. While tests 44-45 indicate 85-86% cadmium removal respectively, this is the case due to the average 300 mg/L cadmium which remained in the wash water solution. As this wash water solution can be recycled, these conditions may be sufficient for the process since the overall cadmium removal from the PLS is 100% and tests 43 and 44 indicate that cadmium is removed in the solids at 98-99%. In tests 44 and 45, the cobalt and nickel removal were also minimized at 3-5% loss with 1% less loss in test 45 compared to 44 for both elements. The difference between these tests (using NaHS 10% wt vs 20% wt) indicates that there is a minimal effect of NaHS concentration on losses.

In another test of an example of a copper sulphide precipitation a pregnant leach solution (PLS) was prepared by leaching lithium-ion battery material using the processes described in international patent publication no. WO2018/218358 entitled A Process, Apparatus, And System For Recovering Materials From Batteries. This PLS contained the following metal concentrations, 4.5 g/L Al, 16.0 g/L Co, 4.9 g/L Cu, 0.6 g/L Fe, 5.3 g/L Li, 9.4 g/L Mn and 21.4 g/L Ni. In a 200 L reactor tank 180 L of PLS was added, with a pH of 1.5 and temperature of approximately 25 degrees Celsius, and was adjusted to an ORP of −85 mV using sodium hydrosulphide (NaHS). The NaHS was added to the reactor tanks as a reductant solution, 10% wt dissolved in water. The slurry in the holding tank was filtered using a plate and frame filter press with a 0.5 micron polypropylene cloth. Following solid-liquid separation the filtrate had a concentration of 3.7 g/L Al, 14.0 g/L Co, 2.5 ppm Cu, 0.5 g/L Fe, 4.6 g/L Li, 7.4 g/L Mn and 18.3 g/L Ni and a solids composition of 0.7% Al, 5.9% Co, 28.3% Cu, 0.3% Fe, 0.6% Li, 0.7% Mn and 5.7% Ni.

In yet another test of an example of a copper sulphide precipitation another pregnant leach solution (PLS) was prepared by leaching lithium-ion battery material as described herein, and the test was conducted at the same pH and temperature conditions as described above. This PLS contained the following metal concentrations, 4.9 g/L Al, 21.2 g/L Co, 5.4 g/L Cu, 1.9 g/L Fe, 6.1 g/L Li, 8.1 g/L Mn and 24.2 g/L Ni. The PLS solution was fed into the first of two reactor tanks connected in series, a third slurry holding tank followed the second reactor tank. Each reactor tank had a holding capacity of 200 L and was equipped with an ORP probe on a feedback control loop. The control loop controlled the addition of sodium hydrosulphide (NaHS) to the reactor tanks. The NaHS was added to the reactor tanks as a solution, 10% wt dissolved in water. The ORP target of the first reactor tank was −75 mV while the target of the second reactor tank was −125 mV to precipitate the Cu as CuS. The slurry in the holding tank was filtered using a plate and frame filter press with a 0.5 micron polypropylene cloth. Following solid-liquid separation the filtrate had an average concentration of 4.8 g/L Al, 16.8 g/L Co, 5 ppm Cu, 1.8 g/L Fe, 5.9 g/L Li, 7.4 g/L Mn and 20.7 g/L Ni and the solids had an average composition of 0.4% Al, 6.8% Co, 28.8% Cu, 0.3% Fe, 0.3% Li, 0.3% Mn and 6.4% Ni.

For the purposes of describing operating ranges and other such parameters herein the phrase “about” or “approximately” means a difference from the stated values or ranges that does not make a material difference in the operation of the systems and processes described herein, including differences that would be understood a person of skill in the relevant art as not having a material impact on the present teachings. For pressures and temperatures about may, in some examples, mean plus or minus 10% of the stated value but is not limited to exactly 10% or less in all situations. For example, a pH of about 2 may be understood to include a pH between 1.8 and 2.2. Similarly, “substantially all” can be understood to mean practically and/or materially all of the substance has been removed from the solution, and may mean separation efficiencies of at least 90%, or higher in some instance as would be understood by a person skilled in the art.

All publications, patents, and patent applications referred to herein are incorporated by reference in their entirety to the same extent as if each individual publication, patent, or patent application was specifically and individually indicated to be incorporated by reference in its entirety. It is understood that the teachings of the present application are exemplary embodiments and that other embodiments may vary from those described. Such variations are not to be regarded as a departure from the spirit and scope of the teachings and may be included within the scope of the following claims.

1. A method of precipitating copper sulphide from an incoming feed stream comprising copper liberated from within battery materials, the method comprising:
a) receiving an incoming feed stream comprising copper entrained in a carrier liquid in a precipitation apparatus;
b) introducing a sulphide reductant to the feed stream to precipitate copper sulphide solids out of the feed stream during a precipitation residence time that is less than 24 hours to produce a copper sulphide slurry;
c) processing the copper sulphide slurry to separate the precipitated copper sulphide solids and provide a copper-depleted stream.

2. The method of claim 1, wherein the reductant is added to the incoming feed stream in step b) of claim 1 to reduce the oxidation reduction potential (ORP) of the copper sulphide slurry to between 0 mV and −200 mV.

3. The method of 2, further comprising after step c) of claim 1 the step of oxidizing the copper-depleted stream downstream from the precipitation apparatus to increase the ORP of the copper-depleted stream.

4.-6. (canceled)

7. The method of claim 1, wherein the sulphide reductant comprises at least one of sodium sulphide, sodium hydrosulphide, and hydrogen sulphide.

8.-11. (canceled)

12. The method of claim 1, wherein the precipitation of the copper sulphide solids in step b) of claim 1 is conducted at an operating temperature is between approximately 5 and 95 degrees Celsius, and wherein the residence time is between about 0.5 and about 4 hours.

13. The method of claim 12, wherein the operating temperature is between 15 and 80 degrees Celsius, and preferably is between about 20 and about 50 degrees Celsius.

14. (canceled)

15. The method of claim 12, wherein the residence time is less than 2.5 hours.

16. (canceled)

17. The method of claim 1, wherein the precipitation of the copper sulphide solids in step 1.b) is conducted at a solution pH that is less than 4.

18. The method of claim 17, wherein the solution pH is between about 0.5 and 3, and preferably is about 1.5.

19. The method of claim 1, wherein processing the copper-depleted stream to separate the precipitated copper sulphide solids comprises using a solid/liquid separator, and wherein the solid/liquid sulphide slurry forms a filter cake on the filter and the output stream comprises filtrate passing through the filter.

20.-22. (canceled)

23. The method of claim 1, further comprising, prior to step a) of claim 1:
a) receiving a black mass feed material comprising at least lithium, copper, and graphite liberated from within battery materials via a physical disassembly process, the black mass feed material has a first concentration of lithium and a first concentration of copper;
b) acid leaching the black mass material at a pH that is less than 4, thereby producing a pregnant leach solution (PLS) comprising less graphite than the black mass feed material, at least 80% of the lithium and the copper from the black mass feed material, the PLS having a second concentration of lithium that is greater than the first concentration of lithium and a second concentration of copper that is greater than the first concentration of copper, wherein the incoming feed stream comprises the PLS.

24. (canceled)

25. A method of processing an incoming feed stream containing at least one target metal liberated from within battery materials via sulphide precipitation, the at least one target metal comprising at least one of copper, cadmium, cobalt, iron and nickel and graphite, the method comprising:
a) receiving an incoming feed stream comprising the at least one target metal entrained in a carrier liquid in a precipitation apparatus;
b) introducing a sulphide reductant to the feed stream to precipitate at least target metal sulphide solids out of the feed stream during a precipitation residence time that is less than 24 hours to produce a target metal sulphide slurry;
c) processing the target metal sulphide slurry to separate at least the precipitated target metal sulphide solids and provide a target metal-depleted stream.

26. The method of claim 25, further comprising prior to step a);
a) receiving a black mass feed material comprising at least lithium, the at least one target metal and graphite liberated from within battery materials via a physical disassembly process, the black mass material having a first concentration of the at least one target metal;
b) acid leaching the black mass feed material at a pH that is less than 4, thereby producing a pregnant leach solution (PLS) comprising less graphite than the black mass feed material, at least 80% of the lithium and the at least one target metal from the black mass feed material, the PLS having a second concentration of the at least one target metal that is greater than the first concentration, wherein the incoming feed stream in step a) of claim 25 comprises the PLS.

27. The method of claim 25, wherein at least 99%% wt of the at least one target metal present in the incoming feed stream is precipitated in step b) of claim 25.

28. The method of claim 25, wherein the reductant is added to the incoming feed stream in step b) of claim 25 to reduce the oxidation reduction potential (ORP) of the target metal sulphide slurry to between 0 mV and −200 mV.

29. The method of 28, further comprising after step c) of claim 25, oxidizing the copper-depleted stream downstream from the precipitation apparatus to increase the ORP of the target metal-depleted stream, and further comprising adjusting the ORP of the target metal-depleted stream to be about 500 mV by introducing at least one of oxygen gas, hydrogen peroxide, and perchloric acid into the target metal-depleted stream.

30.-32. (canceled)

33. The method of claim 25, wherein the sulphide reductant comprises sodium hydrosulphide and is provided as a reductant solution that has a concentration of between about 5-20% wt sulphide reductant in solution.

34.-35. (canceled)

36. The method of claim 25, wherein the precipitation of the target metal sulphide solids in step b) in claim 25 is conducted at an operating temperature that is between about 20 and about 50 degrees Celsius.

37. (canceled)

38. The method of claim 25, wherein the precipitation of the copper sulphide solids in step b) of claim 25 is conducted at a solution pH that is less than 4.

39.-40. (canceled)

41. The method of claim 25, wherein the at least one target metal comprises cadmium, and step b) of claim 25 comprises precipitating cadmium sulphide solids out of the feed stream.

42. (canceled)

43. The method of claim 25 wherein the feed stream further comprises graphite and lithium, and wherein the target metal-depleted stream comprises the lithium.

44. The method of claim 25, wherein the sulphide reductant is introduced so that it has a molar concentration within the feed stream of between 1.2 and 1.6 times the molar concentration of the at least one target metal in the incoming feed stream.

45. (canceled)

46. The method of claim 44, wherein the at least one target metal comprises copper and cadmium, and wherein the sulphide reductant is introduced so that it has a molar concentration within the feed stream of between 1.4 and 1.5 times the sum of the molar concentration of the copper and the cadmium in the incoming feed stream.

47. The method of claim 25, wherein the at least one target metal comprises nickel and step b) of claim 25 comprises precipitating nickel sulphide solids out of the feed stream.
